(19) United States
(12) Patent Application Publication
(10) Pub. No.: US 2024/0150607 A1
(43) Pub. Date: May 9, 2024

(54) TWO-COMPONENT CURABLE COATING AGENT AND MULTILAYER FILM

(71) Applicant: HARIMA CHEMICALS, INC., Hyogo (JP)

(72) Inventors: Masao KIGUCHI, Hyogo (JP); Tetsuya HARADA, Hyogo (JP); Shinji ADACHI, Hyogo (JP); Yosuke TSUTSUMI, Hyogo (JP)

(73) Assignee: HARIMA CHEMICALS, INC., Hyogo (JP)

(21) Appl. No.: 18/280,537

(22) PCT Filed: Mar. 7, 2022
(86) PCT No.: PCT/JP2022/009781

§ 371 Date: Sep. 6, 2023

(30) Foreign Application Priority Data
Mar. 8, 2021 (JP) 2021-035995

(51) Int. Cl. C09D 133/10; C09D 7/20

(52) U.S. Cl. CPC C09D 133/10; C09D 7/20

(57) ABSTRACT

Provided are a two-component curable coating agent capable of forming a surface protective layer having excellent weather resistance, acid resistance, fouling resistance, and elongation properties, and a multilayer film including a surface protective layer that is a cured film of the two-component curable coating agent. The two-component curable coating agent of the present invention includes: a main agent that contains a polyol containing an acrylic polyol having an alicyclic structure and a hydroxyl value of 36 mgKOH/g or more and 125 mgKOH/g or less, and an alkyl polyol; and a curing agent that contains a polyisocyanate. The multilayer film of the present invention includes: a substrate layer; and a surface protective layer that is integrally layered on a first surface of the substrate layer and is a cured film of the two-component curable coating agent.

### TECHNICAL FIELD

The present invention relates to a two-component curable coating agent capable of forming a surface protective layer having excellent weather resistance, acid resistance, fouling resistance, and elongation properties, and also relates to a multilayer film that includes such a surface protective layer, this layer being a cured film of the two-component curable coating agent.

### BACKGROUND ART

Conventionally, articles such as automotives, vehicles, aircrafts, glasses, architectures, and signage have been subjected to surface treatment to protect their surfaces from fouling and damage, thus maintaining their appearance. Such surface treatment is achieved by providing a surface protective layer to the surfaces of the articles. Examples of a surface treatment method include (1) a method in which a coating agent is applied to a surface of an article to form a surface protective layer, and (2) a method in which a multilayer film including a surface protective layer and an adhesive layer is bonded to a surface of an article.

The surface protective layer contains a polyurethane obtained by a reaction of an acrylic polymer having a hydroxyl group with a polyisocyanate. For example, PTL 1 discloses a coating agent containing a urethane modified acrylic resin. PTL 1 discloses that the urethane modified acrylic resin is obtained by a urethane formation reaction of (A) an acrylic polyol having an alicyclic skeleton, a hydroxyl value of 5 to 35 mgKOH/g, and a weight-average molecular weight of 5,000 to 30,000, (B) a polyol having an alicyclic skeleton other than the acrylic polyol, and (C) an organic diisocyanate. In PTL 1, the hydroxyl value of the acrylic polyol (A) is limited to 5 to 35 mgKOH/g, and a hydroxyl value of more than 35 mgKOH/g is excluded to prevent gelation.

### CITATION LIST

### Patent Literature

PTL 1: Japanese Patent Application Laid-Open No. 2011-153204

### SUMMARY OF INVENTION

### Technical Problem

Surface-treated articles are often used outdoors. Surface-treated articles may be exposed to wind, rain, or a high humidity environment, and may be irradiated with light including ultraviolet rays over a long period of time. In such a case, an uneven portion or a discolored portion may be generated on a surface protective layer. Specifically, an uneven portion is first partially generated on a surface of the surface protective layer, gradually made wider on the surface of the surface protective layer with time, and simultaneously a discolored portion, such as a yellow or white-colored portion, is generated in the surface protective layer. Finally, the uneven portion could be spread over the entire surface of the surface protective layer, and simultaneously, the surface protective layer could be entirely discolored into yellow or white. The generation of the uneven portion and the discoloration on the surface protective layer are considered to be due to degradation of components contained in the surface protective layer by light, fixation of solutes contained in rain, air moisture, or the like to the surface of the surface protective layer, and the like. The generation of the uneven portion and the discolored portion on the surface protective layer causes defects in the appearance of the surface protective layer. Therefore, the surface protective layer is required to have excellent weather resistance.

Exposure of the surface of the surface-treated article to acid rain during rainfall may whiten the surface protective layer, resulting in an appearance defect. Therefore, the surface protective layer is also required to have excellent acid resistance.

Attachment of oil residues, such as those caused by fingerprints, to the surface protective layer may also cause appearance defects. Therefore, the surface protective layer is also required to have excellent fouling resistance so that the oil residues attached to the surface protective layer can be easily wiped off.

When the surface protective layer is bonded to the surface of the article or the surface-treated article is molded, a tensile force may be applied to the surface protective layer. However, when the elongation properties of the surface protective layer are low, the surface protective layer cannot withstand the tensile force, and cracking or cleavage may possibly occur. Therefore, the surface protective layer is also required to have excellent elongation properties.

As described above, PTL 1 discloses the coating agent containing a urethane modified acrylic resin. A surface protective layer formed from this coating agent has problems in that weather resistance, acid resistance, fouling resistance, and the like are low.

Therefore, an object of the present invention is to provide a two-component curable coating agent capable of forming a surface protective layer having excellent weather resistance, acid resistance, fouling resistance, and elongation properties, and to provide a multilayer film that includes a surface protective layer, this layer being a cured film of the two-component curable coating agent.

### Solution to Problem

<Two-Component Curable Coating Agent>

The two-component curable coating agent of the present invention includes;
a main agent that contains a polyol containing an acrylic polyol having an alicyclic structure and a hydroxyl value of 36 mgKOH/g or more and 125 mgKOH/g or less, and an alkyl polyol: and
a curing agent that contains a polyisocyanate.

In the two-component curable coating agent of the present invention, the polyol contained in the main agent is reacted with the polyisocyanate contained in the curing agent, to form a polyurethane. Thus, the two-component curable coating agent can be cured to form a surface protective layer. Since the polyol of the main agent contains an acrylic polyol having an alicyclic structure and a hydroxyl value of 36 mgKOH/g or more and 125 mgKOH/g or less, the two-component curable coating agent of the present invention can form a surface protective layer having excellent acid resistance, weather resistance, and fouling resistance. Since the acrylic polyol has an alicyclic structure, the elongation properties of the surface protective layer may decrease. However, since the polyol of the main agent additionally contains an alkyl polyol, the two-component curable coating agent of the present invention can form a surface protective layer having excellent elongation properties regardless of use of the acrylic polyol described above. Furthermore, the fouling resistance of the surface protective layer can also be improved by use of the alkyl polyol.

Since a predetermined acrylic polyol and a predetermined alkyl polyol are used in combination as the polyol contained in the main agent as described above, the two-component curable coating agent of the present invention can form a surface protective layer having excellent weather resistance, acid resistance, fouling resistance, and elongation properties.

[Main Agent]

The two-component curable coating agent of the present invention includes a main agent containing a polyol. The polyol contained in the main agent contains an acrylic polyol and an alkyl polyol.

(Acrylic Polyol)

The polyol contained in the main agent of the two-component curable coating agent of the present invention contains an acrylic polyol. The acrylic polyol has an alicyclic structure and a hydroxyl value of 36 mgKOH/g or more and 125 mgKOH/g or less.

In the present invention, the term “alicyclic structure” refers to a structure in which carbon atoms are bonded to form a ring and which does not have aromaticity. In addition, the term “aromaticity” means a ring system having (4n+2) π-electrons (n is a natural number) according to Huckel's rule.

Examples of the alicyclic structure in the acrylic polyol include a cycloalkane structure such as a cyclopropane structure, a cyclobutane structure, a cyclopentane structure, a cyclohexane structure, a cyclooctane structure, and a cyclodecane structure, a tetrahydrodicyclopentadiene structure, an adamantane structure, and an isobornyl structure. As the alicyclic structure, a cycloalkane structure is preferable. The acrylic polyol may contain one type of alicyclic structure or two or more types of alicyclic structures.

The acrylic polyol is an acrylic polymer obtained by polymerizing a (meth)acrylic monomer and having a hydroxyl group in a terminal or side chain. The acrylic polyol can be obtained by polymerizing a (meth)acrylic monomer using a conventional method for producing an acrylic polymer in the presence of a radical polymerization initiator.

The term “(meth)acrylic” means acrylic or methacrylic. The term “(meth)acrylate” means acrylate or methacrylate.

(Hydroxyl Group-Containing (Meth)Acrylic Monomer)

The acrylic polyol preferably contains a hydroxyl group-containing (meth)acrylic monomer component. That is, the acrylic polyol is preferably a polymer of a (meth)acrylic monomer containing a hydroxyl group-containing (meth)acrylic monomer.

Examples of the hydroxyl group-containing (meth)acrylic monomer include 2-hydroxyethyl (meth)acrylate, 2-hydroxypropyl (meth) acrylate, 3-hydroxypropyl (meth)acrylate, 2-hydroxybutyl (meth) acrylate, 4-hydroxybutyl (meth) acrylate, 6-hydroxyhexyl (meth) acrylate, 8-hydroxyoctyl (meth)acrylate, 10-hydroxydecyl (meth)acrylate, and 12-hydroxylauryl (meth) acrylate. Among these, 2-hydroxyethyl (meth)acrylate is preferable. The hydroxyl group-containing (meth)acrylic monomer may be used alone or two or more types thereof may be used in combination.

In the acrylic polyol, the content of the hydroxyl group-containing (meth)acrylic monomer component is preferably 8% by mass or more, more preferably 9% by mass or more, and particularly preferably 10% by mass or more. In the acrylic polyol, the content of the hydroxyl group-containing (meth)acrylic monomer component is preferably 27% by mass or less, more preferably 26% by mass or less, and particularly preferably 25% by mass or less. The hydroxyl group-containing (meth)acrylic monomer component, when its content is equal to or more than 8% by mass, allows for the easy adjustment of the hydroxyl value of the acrylic polyol to 36 mgKOH/g or more. As a result, a surface protective layer having excellent acid resistance, weather resistance, and fouling resistance can be formed. The hydroxyl group-containing (meth)acrylic monomer component, when its content is equal to or less than 27 mass %, can maintain excellent elongation properties of the surface protective layer.

(Meth)Acrylic Monomer Having an Alicyclic Structure)

The acrylic polyol preferably further contains a (meth)acrylic monomer component having an alicyclic structure. Therefore, the acrylic polyol preferably contains a hydroxyl group-containing (meth)acrylic monomer component and a (meth)acrylic monomer component having an alicyclic structure. That is, the acrylic polyol is preferably a polymer of (meth)acrylic monomers containing a hydroxyl group-containing (meth)acrylic monomer and a (meth)acrylic monomer having an alicyclic structure.

The use of a (meth)acrylic monomer having an alicyclic structure can facilitate obtention of an acrylic polyol having an alicyclic structure. Such an acrylic polyol allows for the formation of a surface protective layer having excellent acid resistance, weather resistance, and fouling resistance.

The (meth)acrylic monomer having an alicyclic structure preferably does not have a hydroxyl group.

Examples of the alicyclic structure in the (meta)acrylic monomer having an alicyclic structure include a cycloalkane structure such as a cyclopropane structure, a cyclobutane structure, a cyclopentane structure, a cyclohexane structure, a cyclooctane structure, and a cyclodecane structure, a tetrahydrodicyclopentadiene structure, an adamantane structure, and an isobornyl structure. As the alicyclic structure, a cycloalkane structure is preferable.

Specific examples of the (meth)acrylic monomer having an alicyclic structure include isobornyl acrylate, isobornyl methacrylate, cyclohexyl acrylate, cyclohexyl methacrylate, dicyclopentanyl acrylate, 1,4-cyclohexanedimethanol monoacrylate, 1-ethylcyclohexyl acrylate, 1-ethylcyclooctyl acrylate, 2-methyl-2-adamantyl acrylate, 2-methyl-2-adamantyl methacrylate, and adamantyloxymethyl methacrylate. The (meth)acrylic monomer having an alicyclic structure may be used alone, or two or more types thereof may be used in combination.

Among these, as the (meth)acrylic monomer having an alicyclic structure, cyclohexyl acrylate, cyclohexyl methacrylate, isobornyl acrylate and isobornyl methacrylate are preferable. Cyclohexyl acrylate and cyclohexyl methacrylate are more preferable, and cyclohexyl methacrylate is more preferable.

In the acrylic polyol, the content of the (meth)acrylic monomer component having an alicyclic structure is preferably 10% by mass or more, more preferably 15% by mass or more, and particularly preferably 20% by mass or more. In the acrylic polyol, the content of the (meth)acrylic monomer component having an alicyclic structure is preferably 50% by mass or less, more preferably 45% by mass or less, and particularly preferably 42% by mass or less. The (meth)acrylic monomer component having an alicyclic structure, when its content is equal to or more than 10% by mass, allows for the formation of a surface protective layer having excellent acid resistance, weather resistance, fouling resistance, and elongation properties. The (meth)acrylic monomer component having an alicyclic structure, when its content is equal to or less than 50% by mass or less, can maintain excellent elongation properties of the surface protective layer.

(Alkyl (meth)acrylate) The acrylic polyol preferably further contains an alkyl (meth)acrylate component. Therefore, the acrylic polyol preferably contains a hydroxyl group-containing (meth)acrylic monomer component, a (meth)acrylic monomer component having an alicyclic structure, and an alkyl (meth)acrylate component. That is, the acrylic polyol is preferably a polymer of (meth)acrylic monomers including a hydroxyl group-containing (meth)acrylic monomer, a (meth)acrylic monomer having an alicyclic structure, and an alkyl (meth)acrylate. The acrylic polyol is more preferably a copolymer of a hydroxyl group-containing (meth)acrylic monomer, a (meth)acrylic monomer having an alicyclic structure, and an alkyl (meth)acrylate.

The alkyl (meth)acrylate preferably does not have an alicyclic structure. The alkyl (meth)acrylate preferably also does not have a hydroxyl group.

As the alkyl group in the alkyl (meth)acrylate, a group represented by —CₙH₂ₙ₊₁ (n is a natural number) is preferable, and a linear or branched alkyl group is preferable.

Examples of the alkyl (meth)acrylate include methyl (meth)acrylate, ethyl (meth)acrylate, propyl (meth)acrylate, butyl (meth)acrylate, pentyl (meth)acrylate, hexyl (meth)acrylate, heptyl (meth)acrylate, octyl (meth)acrylate, 2-ethylhexyl (meth)acrylate, nonyl (meth)acrylate, decyl (meth)acrylate, lauryl (meth)acrylate, tridecyl (meth)acrylate, and myristyl (meth)acrylate. The alkyl (meth)acrylate may be used alone, or two or more types thereof may be used in combination.

Among these, as the alkyl (meth)acrylate, butyl (meth)acrylate, lauryl (meth)acrylate, and myristyl (meth)acrylate are preferable, and butyl (meth)acrylate and lauryl (meth)acrylate are more preferable.

In the acrylic polyol, the content of the alkyl (meth)acrylate component is preferably 30% by mass or more, more preferably 35% by mass or more, and particularly preferably 42% by mass or more. In the acrylic polyol, the content of the alkyl (meth)acrylate component is preferably 80% by mass or less, more preferably 70% by mass or less, and particularly preferably 66% by mass or less. The alkyl (meth)acrylate component, when its content is equal to or more than 30% by mass, can impart excellent elongation properties to the surface protective layer. The alkyl (meth)acrylate component, when its content is equal to or less than 80% by mass, can impart excellent acid resistance to the surface protective layer.

As a polymerization method of the acrylic polyol, a conventionally known method is employed. Examples thereof include a method of polymerizing the above-described monomers in the presence of a radical polymerization initiator. Specifically, for example, there is a method in which the above-described monomers, a polymerization initiator, and a polymerization solvent are supplied into a reaction vessel, and are heated at a temperature of 60 to 80° C. for 4 to 48 hours, so that the monomers are radically polymerized.

The hydroxyl value of the acrylic polyol is 36 mgKOH/g or more, preferably 54 mgKOH/g or more, and more preferably 68 mgKOH/g or more. The hydroxyl value of the acrylic polyol is 125 mgKOH/g or less, preferably 90 mgKOH/g or less, and more preferably 70 mgKOH/g or less. The acrylic polyol, when its hydroxyl value is equal to or more than 36 mgKOH/g, allows for the formation of a surface protective layer having excellent weather resistance, acid resistance, fouling resistance, and elongation properties. The acrylic polyol, when its hydroxyl value is equal to or less than 125 mgKOH/g, can maintain excellent elongation properties of the surface-protective layer.

The hydroxyl value of the acrylic polyol refers to a value measured in accordance with 4.2 B method in JIS K 1557-1:2007 (ISO 14900:2001) “Plastics-Polyols for use in the production of polyurethane-Part 1: Determination of hydroxyl value”.

The glass transition temperature of the acrylic polyol is preferably −60° C. or higher, more preferably −50° C. or higher, and particularly preferably −42° C. or higher. The glass transition temperature of the acrylic polyol is preferably 0° C. or lower, more preferably −1° C. or lower, and particularly preferably −2° C. or lower. The acrylic polyol, when its glass transition temperature is equal to or higher than −60° C., can improve the acid resistance and fouling resistance of the surface protective layer. The acrylic polyol, when its glass transition temperature is equal to or lower than 0° C., can improve the elongation properties of the surface protective layer.

The glass transition temperature of the acrylic polyol can be determined from Fox equation represented by the following equation (1) using the content ratio (weight fraction) and glass transition temperature of each monomer constituting the acrylic polyol.

$$\begin{matrix}[ Equation 1 ] & \\ 1 / ( 273 + Tg ) = {\sum }_{i = 1}^{n} [ Wi / ( 273 + Tgi ) ] & ( 1 )\end{matrix}$$

(in the equation (1), Tg is a glass transition temperature (° C.) of the acrylic polyol, Wi is a content ratio (weight fraction) of a monomer i, Tgi is a glass transition temperature (° C.) of the monomer i, and n is an integer indicating the number of monomer types.)

Herein, the “glass transition temperature of the monomer i” refers to the glass transition temperature of a homopolymer in which the monomer i is homopolymerized. The glass transition temperature of the homopolymer of the monomer i is measured by differential scanning calorimetry (DSC) in accordance with JIS K 7121 (1987). The thus measured value is the “glass transition temperature of the monomer i”.

The weight-average molecular weight of the acrylic polyol is preferably 8,000 or more, more preferably 9,000 or more, and particularly preferably 10,000 or more. The weight-average molecular weight of the acrylic polyol is preferably 120,000 or less, more preferably 110,000 or less, and particularly preferably 100,000 or less. The acrylic polyol, when its weight-average molecular weight is equal to or more than 8,000, can improve the acid resistance and weather resistance of the surface protective layer. The acrylic polyol, when its weight-average molecular weight is equal to or less than 120,000, can maintain the excellent elongation properties of the surface protective layer, and can improve the fouling resistance of the surface protective layer.

The weight-average molecular weight of the acrylic polyol refers to a value obtained by converting the molecular weight measured by gel permeation chromatography (GPC) into a value in terms of polystyrene. For example, measurement can be performed under the following measurement conditions.

An acrylic polyol is dissolved in tetrahydrofuran to obtain a measurement sample in which the concentration of the acrylic polyol is 2.0 g/L. The measurement sample is used to measure the weight-average molecular weight of the acrylic polyol by gel permeation chromatography (GPC) equipped with a differential refractive index detector (RID). The weight-average molecular weight of the acrylic polyol can be measured by the following measurement apparatus and measurement conditions:
Measurement apparatus: “HLC-8320GPC” manufactured by Tosoh Corporation
Differential refractive index detector: RI detector installed in the measurement apparatus
Column: two columns of “TSKgel SuperHZM-H” manufactured by Tosoh Corporation
Mobile phase: tetrahydrofuran
Column flow rate: 0.35 mL/min
Sample concentration: 2.0 g/L
Injection volume: 10 μL
Measurement temperature: 40° C.
Molecular-weight marker: standard polystyrene (standard material manufactured by POLYMER LABORATORIES LTD.)

### (Polystyrene-Medium Molecular Weight Calibration Kit)

In the two-component curable coating agent of the present invention, the content of the acrylic polyol in the polyol contained in the main agent is preferably 25 parts by mass or more, more preferably 30 parts by mass or more, and particularly preferably 35 parts by mass or more, relative to 100 parts by mass of the total amount of the acrylic polyol and the alkyl polyol. The content of the acrylic polyol in the polyol contained in the main agent is preferably 98 parts by mass or less, more preferably 94 parts by mass or less, and particularly preferably 90 parts by mass or less, relative to 100 parts by mass of the total amount of the acrylic polyol and the alkyl polyol. The acrylic polyol, when its content is equal to or more than 25 parts by mass, allows for the formation of a surface protective layer having excellent weather resistance, acid resistance, fouling resistance, and elongation properties. The acrylic polyol, when its content is equal to or less than 98 parts by mass, allows for the formation of a surface protective layer having excellent weather resistance, acid resistance, fouling resistance, and elongation properties.

(Alkyl Polyol)

The polyol contained in the main agent of the two-component curable coating agent of the present invention includes an alkyl polyol in addition to the acrylic polyol described above.

In the present invention, the term “alkyl polyol” refers to a chain-like saturated hydrocarbon or a saturated hydrocarbon having a saturated alicyclic structure in which at least two hydrogen atoms in one molecule are substituted with a hydroxyl group (—OH).

A chain-like saturated hydrocarbon in which at least two hydrogen atoms in one molecule are substituted with a hydroxyl group (—OH) is referred to as a “chain-like alkyl polyol”.

A saturated hydrocarbon having a saturated alicyclic structure in which at least two hydrogen atoms in one molecule are substituted with a hydroxyl group (—OH) is referred to as a “cycloalkyl polyol”.

The “saturated alicyclic structure” refers to an alicyclic structure that does not contain an unsaturated bond such as a carbon-carbon double bond or a carbon-carbon triple bond. Examples of the saturated alicyclic structure include a cycloalkane structure such as a cyclopropane structure, a cyclobutane structure, a cyclopentane structure, a cyclohexane structure, a cyclooctane structure, and a cyclodecane structure, a tetrahydrodicyclopentadiene structure, and an adamantane structure. Examples of the saturated hydrocarbon having a saturated alicyclic structure include dimethylcyclohexane, diethylcyclohexane, adamantane, tetrahydrodicyclopentadiene, and tetramethylcyclobutane.

In the alkyl polyol, the number of hydroxyl groups per molecule is 2 or more. In the alkyl polyol, the number of hydroxyl groups per molecule is preferably 5 or less, and more preferably 3 or less. It is particularly preferable that the alkyl polyol have two hydroxyl groups in one molecule.

Specifically, examples of the alkyl polyol include:
a chain-like alkyl polyol such as propanediol, butanediol, pentanediol, hexanediol, heptanediol, octanediol, nonanediol, 2,4-dimethyl-2-ethylhexane-1,3-diol, 2,4-diethyl-1,5-pentanediol, 2-methyl-1,3-propanediol, 2-methyl-2,4-pentanediol, 2-methyl-1,6-hexanediol, 2-methyl-2-ethyl-1,3-propanediol, 2-methyl-2-propyl-1,3-propanediol, 2-ethyl-2-butyl-1,3-propanediol, 2-ethyl-2-isobutyl-1,3-propanediol, 3-methyl-1,5-pentanediol, 2,2-dimethyl-1,3-propanediol, 1,3,5-trimethyl-1,3-pentanediol, and 2,2,4-trimethyl-1,6-hexanediol; and
a cyclohexanedimethanol such as 1,2-cyclohexanedimethanol, 1,3-cyclohexanedimethanol, and 1,4-cyclohexanedimethanol, a cyclohexanediethanol such as 1,2-cyclohexanediethanol, 1,3-cyclohexanediethanol, and 1,4-cyclohexanediethanol, and a cycloalkyl polyol such as tricyclodecanedimethanol, adamantanediol, and 2,2,4,4-tetramethyl-1,3-cyclobutanediol. The alkyl polyol may be used alone, or two or more types thereof may be used in combination.

Among these, the alkyl polyol is preferably a cycloalkyl polyol, more preferably cyclohexanedimethanol and cyclohexanediethanol, and more preferably cyclohexanedimethanol. The use of the cycloalkyl polyol can further improve the fouling resistance of the surface protective layer.

The content of the cycloalkyl polyol in the alkyl polyol is preferably 75% by mass or more, more preferably 90% by mass or more, more preferably 95% by mass or more, and particularly preferably 100% by mass. It is particularly preferable that the alkyl polyol consist only of a cycloalkyl polyol. The cycloalkyl polyol, when its content is equal to or more than 75% by mass, can improve the fouling resistance of the surface protective layer.

In the two-component curable coating agent of the present invention, the content of the alkyl polyol in the polyol contained in the main agent is preferably 2 parts by mass or more, more preferably 6 parts by mass or more, and particularly preferably 10 parts by mass or more, relative to 100 parts by mass of the total amount of the acrylic polyol and the alkyl polyol. The content of the alkyl polyol in the polyol contained in the main agent is preferably 75 parts by mass or less, more preferably 70 parts by mass or less, and particularly preferably 65 parts by mass or less, relative to 100 parts by mass of the total amount of the acrylic polyol and the alkyl polyol. The alkyl polyol, when its content is equal to or more than 2 parts by mass, can improve the fouling resistance of the surface protective layer. The alkyl polyol, when its content is equal to or less than 75 parts by mass, can impart excellent elongation properties to the surface protective layer, and can also maintain excellent acid resistance of the surface protective layer.

The main agent of the two-component curable coating agent may include a curing catalyst. Examples of the curing catalyst include an organometallic compound such as dibutyltin oxide, tin 2-ethylcaproate, tin octylate, and dibutyltin dilaurate. The curing catalyst may be used alone, or two or more types thereof may be used in combination.

[Curing Agent]

The two-component curable coating agent of the present invention includes a curing agent containing a polyisocyanate. The polyisocyanate preferably has two or more isocyanate groups (—NCO) in one molecule, but preferably has three or more isocyanate groups (—NCO) in one molecule. The polyisocyanate having three or more isocyanate groups in one molecule can improve the fouling resistance of the surface protective layer.

Examples of the polyisocyanate include an aliphatic polyisocyanate and a polyisocyanate having an alicyclic structure. The polyisocyanate may be used alone, or two or more types thereof may be used in combination.

Examples of the aliphatic polyisocyanate include an acyclic aliphatic polyisocyanate such as ethylene diisocyanate, tetramethylene diisocyanate, hexamethylene diisocyanate, dodecamethylene diisocyanate, 1,6,11-undecanetriisocyanate, 2,2,4-trimethylhexamethylene diisocyanate, 2,6-diisocyanatomethyl caproate, bis(2-isocyanatoethyl)fumarate, bis(2-isocyanatoethyl)carbonate, and 2-isocyanatoethyl-2,6-diisocyanatohexanoate. Among these, hexamethylene diisocyanate is preferable.

Examples of the polyisocyanate having an alicyclic structure include 4,4′-dicyclohexylmethane diisocyanate (hydrogenated MDI), isophorone diisocyanate, methylcyclohexylene diisocyanate (hydrogenated TDI), and 1,3-bis(isocyanatomethyl)cyclohexane (hydrogenated m-XDI).

Examples of the polyisocyanate also include a modified polyisocyanate. Examples of the modified polyisocyanate include an isocyanurate form, a biuret form, and an adduct of the polyisocyanate. Three molecules of a polyisocyanate can form an isocyanurate or biuret form. Three molecules of a polyisocyanate can be reacted with trimethylolpropane to form a trimeric adduct.

Examples of the modified polyisocyanate include:
biuret and isocyanurate forms of an aliphatic polyisocyanate such as ethylene diisocyanate, tetramethylene diisocyanate, hexamethylene diisocyanate, and dodecamethylene diisocyanate;
biuret and isocyanurate forms of a polyisocyanate having an alicyclic structure such as 4,4′-dicyclohexylmethane diisocyanate (hydrogenated MDI), isophorone diisocyanate, methylcyclohexylene diisocyanate (hydrogenated TDI), and 1,3-bis(isocyanatomethyl)cyclohexane (hydrogenated m-XDI);
a trimeric adduct of trimethylolpropane (TMP) and hydrogenated MDI;
a trimeric adduct of 3 moles of any one of the polyisocyanates such as isophorone diisocyanate, methylcyclohexylene diisocyanate (hydrogenated TDI), and 1,3-bis(isocyanatomethyl)cyclohexane (hydrogenated m-XDI) with 1 mole of trimethylolpropane (TMP);
an adduct of trimethylolpropane (TMP) with two moles of isophorone diisocyanate and one mole of hexamethylene diisocyanate (HDI); and
a bifunctional polyurethane diisocyanate obtained by performing an addition reaction of a diol with an aliphatic diisocyanate such as ethylene diisocyanate, tetramethylene diisocyanate, and hexamethylene diisocyanate.

As the polyisocyanate, a biuret form of a polyisocyanate and an isocyanurate form of a polyisocyanate are preferable. An isocyanurate form of a polyisocyanate is more preferable, and an isocyanurate form of an aliphatic polyisocyanate is particularly preferable. These polyisocyanates allow for the formation of a surface protective layer having excellent weather resistance, acid resistance, and fouling resistance.

In the two-component curable coating agent, the equivalent ratio (isocyanate group/hydroxyl group) of the isocyanate group of the polyisocyanate contained in the curing agent to the hydroxyl group of the polyol contained in the main agent is preferably 0.8 or more, and more preferably 0.9 or more. In the two-component curable coating agent, the equivalent ratio (isocyanate group/hydroxyl group) of the isocyanate group of the polyisocyanate contained in the curing agent to the hydroxyl group of the polyol contained in the main agent is preferably 1.2 or less, and more preferably 1.1 or less. The equivalent ratio (isocyanate group/hydroxyl group) being equal to or more than 0.8 allows for the formation of a surface protective layer having excellent fouling resistance. The equivalent ratio (isocyanate group/hydroxyl group) being equal to or less than 1.2 allows for the formation of a surface protective layer having excellent weather resistance.

In order to determine the equivalent ratio (isocyanate group/hydroxyl group) of the isocyanate group of the polyisocyanate contained in the curing agent to the hydroxyl group of the polyol contained in the main agent, the number of the isocyanate groups of the polyisocyanate is divided by the number of the hydroxyl groups of the entire polyol.

The polyol contained in the main agent contains a plurality of types of polyols, such as an acrylic polyol and an alkyl polyol. Therefore, the number of the hydroxyl groups of the entire polyol is a value determined by the following expression.

Number of hydroxyl groups of entire polyol=(W₁×H₁/56100)+(W₂×H₂/56100)+ . . . +(Wₘ×Hₘ/56100)

(In the expression, W m is the content (g) of the m-th polyol in the entire polyol, H m is the hydroxyl value of the m-th polyol, and m is an integer indicating the number of polyol types.)

The hydroxyl value of the m-th polyol refers to a value measured in accordance with 4.2 B method in JIS K 1557-1:2007(ISO 14900:2001) “Plastics-Polyols for use in the production of polyurethane-Part 1: Determination of hydroxyl value”.

The number of the isocyanate groups of the polyisocyanate is determined by the following expression. An isocyanate equivalent refers to a value obtained by dividing the molecular weight of a polyisocyanate by the number of isocyanate groups in one molecule of the polyisocyanate. Specifically, the isocyanate equivalent is a value measured in accordance with JIS K 1603.

Number of isocyanate groups of polyisocyanate=(content (g) of polyisocyanate)/(isocyanate equivalent)

Additives may be added to the main agent and the curing agent of the two-component curable coating agent as necessary within a range not impairing the physical properties of the two-component curable coating agent. Examples of the additive include an antioxidant, a light stabilizer, a heat-resistant stabilizer, an antistatic agent, and an antifoaming agent.

The main agent and the curing agent of the two-component curable coating agent may contain a solvent. When the main agent of the two-component curable coating agent contains a solvent, the solid content concentration of the main agent is preferably 10 to 90% by mass, and more preferably 20 to 80% by mass. When the curing agent of the two-component curable coating agent contains a solvent, the solid content concentration of the curing agent is preferably 10 to 90% by mass, and more preferably 20 to 80% by mass.

Examples of the solvent include hydrocarbons such as pentane, hexane, heptane, and cyclohexane; ketones such as acetone, methyl ethyl ketone, methyl isobutyl ketone, and cyclohexanone; and esters such as ethyl acetate and butyl acetate. The solvent may be used alone, or two or more types thereof may be used in combination.

It is preferable that the two-component curable coating agent of the present invention be used to form a surface protective layer for protecting the surface of an article. As the surface protective layer, a cured film of the two-component curable coating agent of the present invention can be used. The surface protective layer is preferably used in a multilayer film that includes the surface protective layer. For example, when the multilayer film is bonded to the surface of the article with an adhesive or the like, the surface protective layer can be applied to the surface of the article.

The two-component curable coating agent of the present invention allows for the formation of the surface protective layer having excellent weather resistance, acid resistance, and fouling resistance as described above. The use of such a surface protective layer can maintain a visually favorable appearance of the surface of the article over a long period of time. The surface protective layer that is formed from the two-component curable coating agent of the present invention also has excellent flexibility and elongation properties. To bond the multilayer film that includes the surface protective layer to the surface of the article, the multilayer film is placed on the surface of the article, and a squeegee (pallet) is then pressed and slid on the surface protective layer. During this action, a tensile force is applied to the multilayer film by the squeegee, but the surface protective layer can withstand such a tensile force. The surface protective layer being able to withstand the tensile force allows for a reduction in cracking and cleavage in the surface protective layer. Therefore, the surface protective layer formed from the two-component curable coating agent of the present invention can be suitably used as the multilayer film. Hereinafter, the multilayer film including the surface protective layer will be described.

<Multilayer Film>

The multilayer film of the present invention includes a substrate layer and the surface protective layer, which is the cured film of the two-component curable coating agent as described above, that is integrally layered on a first surface of the substrate layer.

[Substrate Layer]

The multilayer film of the present invention includes the substrate layer. The substrate layer preferably contains at least one of a thermoplastic resin and a thermoplastic elastomer. Thus, the elongation properties of the multilayer film can be improved.

Examples of the thermoplastic resin include a polyurethane resin, a polyolefin resin, a polyester resin, a polyamide resin, a polyvinyl resin, and a polycarbonate resin. Examples of the thermoplastic elastomer include a thermoplastic polyurethane elastomer, a thermoplastic styrene elastomer, a thermoplastic acrylic elastomer, a thermoplastic polyolefin elastomer, a thermoplastic polyvinyl chloride elastomer, a thermoplastic polyester elastomer, and a thermoplastic polyamide elastomer. Each of the thermoplastic resin and the thermoplastic elastomer may be used alone, or two or more types thereof may be used in combination.

In particular, the substrate layer preferably contains a thermoplastic resin, and more preferably contains a polyurethane resin. The substrate layer preferably contains a thermoplastic elastomer, and more preferably contains a thermoplastic polyurethane elastomer. The thickness of the substrate layer is not particularly limited, may be 10 to 300 μm, and is preferably 20 to 200 μm.

[Surface Protective Layer]

The multilayer film of the present invention includes the surface protective layer integrally layered on the first surface of the substrate layer. The surface protective layer is the cured film of the two-component curable coating agent.

Herein, an arbitrary surface of the substrate layer is the “first surface of the substrate layer”, and a surface of the substrate layer on a side opposite to the first surface is a “second surface of the substrate layer”. At least one or both of the first and second surfaces of the substrate layer is preferably a surface having the largest area of the substrate layer.

The thickness of the surface protective layer is preferably 1 μm or more, and more preferably 5 μm or more. The thickness of the surface protective layer is preferably 50 μm or less, and more preferably 30 μm or less. A surface protective layer having a thickness of 1 μm or more can improve scratch resistance. A surface protective layer having a thickness of 50 μm or less can reduce the occurrence of appearance defect.

As a method for forming the surface protective layer, a method in which the main agent and curing agent in the two-component curable coating agent are mixed and the two-component curable coating agent is applied to the first surface of the substrate layer and heated is used. It is preferable that immediately before applying the two-component curable coating agent to the substrate layer, the main agent and curing agent in the two-component curable coating agent be mixed.

Examples of a method for applying the two-component curable coating agent to the substrate layer include application methods, such as a dip coating method, a spray coating method, a roll coating method, a doctor blade method, and a screen printing method, and casting using a bar coater, an applicator, or the like.

The two-component curable coating agent applied to the substrate layer is heated, resulting in thermal curing. By heating, the polyol contained in the two-component curable coating agent is reacted with the polyisocyanate contained in the two-component curable coating agent to form a polyurethane, and the two-component curable coating agent is cured to form the surface protective layer.

The heating temperature of the two-component curable coating agent is preferably 60 to 180° C., and more preferably 80 to 150° C. The heating time of the two-component curable coating agent is preferably 1 to 30 minutes, and more preferably 1 to 10 minutes.

[Adhesive Layer]

The multilayer film of the present invention preferably further includes an adhesive layer that is integrally layered on the second surface of the substrate layer. Using the adhesive layer, the multilayer film can be easily bonded to the surface of the article or the like.

The thickness of the adhesive layer is not particularly limited, is preferably 10 to 200 μm, and more preferably 20 to 100 μm.

The adhesive layer includes an adhesive. The adhesive is not particularly limited. Examples thereof include an acrylic adhesive, a rubber-based adhesive, a vinyl alkyl ether-based adhesive, a silicone-based adhesive, a polyester-based adhesive, a polyamide-based adhesive, a polyurethane-based adhesive, a fluorine-based adhesive, and an epoxy-based adhesive. Among these, an acrylic adhesive is preferred. The adhesive may be used alone, or two or more types thereof may be used in combination.

Furthermore, the adhesive layer may optionally contain an additive. Examples of the additive include a plasticizer, a filler, an anti-aging agent, an antioxidant, a colorant such as a pigment or a dye such as carbon black, and a tackifier such as a rosin derivative resin, a polyterpene resin, a petroleum resin, and an oil-soluble phenolic resin. The adhesive may be crosslinked by a general-purpose crosslinking agent such as an aziridine-based crosslinking agent, an epoxy-based crosslinking agent, or an isocyanate-based crosslinking agent.

The formation of the adhesive layer is not particularly limited. To form the adhesive layer, an adhesive composition containing the adhesive, and if necessary an additive and a crosslinking agent, is applied to the second surface of the substrate layer followed by drying. Thus, the adhesive layer that is integrally layered on the second surface of the substrate layer is formed.

(Metallic Lustrous Layer)

The multilayer film of the present invention may further include a metallic lustrous layer. Because of the metallic lustrous layer, the multilayer film can express lustrous properties, and can decorate the surface of an article such as an automotive in a metallic tone.

The metallic lustrous layer is not particularly limited. The metallic lustrous layer may be disposed on at least one of the first and second surfaces of the substrate layer. If necessary, an anchor coating layer may be additionally placed between the metallic lustrous layer and a layer adjacent to the metallic lustrous layer.

The metallic lustrous layer preferably contains a metal. Examples of the metal include copper, nickel, chromium, titanium, cobalt, molybdenum, zirconium, tungsten, palladium, indium, tin, gold, silver, and aluminum. Among these, indium and aluminum are preferable. These metals may be used alone, or two or more types thereof may be used in combination. The thickness of the metallic lustrous layer is preferably 1 nm to 100 nm, and more preferably 1.5 nm to 7.5 nm.

The anchor coating layer is used to improve the adhesion between the metallic lustrous layer and the layer adjacent to the metallic lustrous layer. The anchor coating layer preferably includes an anchor coating agent. Examples of the anchor coating agent include a polyester-based resin, a melamine-based resin, a urea-based resin, a urea-melamine-based resin, a urethane resin, an acrylic resin, and a nitrocellulose resin. These anchor coating agents may be used alone, or two or more types thereof may be used in combination. The thickness of the anchor coating layer is not particularly limited, and may be 0.01 to 1 μm.

The multilayer film of the present invention is preferably used to protect the surface of an article, such as a transportation vehicle including an automotive, a train, and an aircraft, a glass, an architecture, and a signage. That is, the multilayer film of the present invention is preferably used as a multilayer film for surface protection. For example, a multilayer film that is bonded to and integrated with the surface of the article by intermediary of the adhesive or the adhesive layer can protect the surface of the article against fouling and damage, and such a film can also maintain the appearance of an article over a long period of time.

In particular, the multilayer film of the present invention can be suitably used as an automotive surface protecting multilayer film that protects the surface of an automotive. For example, the multilayer film can be used by bonding to and integrating with a painted surface of an automotive by intermediary of the adhesive layer. Thus, a visually favorable appearance of the surface of the automotive can be maintained over a long period of time.

The surface protective layer formed from the cured film of the two-component curable coating agent of the present invention can be suitably used as the multilayer film. The application of the surface protective layer is not limited to such a form. For example, when the two-component curable coating agent is applied directly to the surface of the article, the surface protective layer can be formed on the surface of the article. Such a surface protective layer is integrally layered on the surface of the article without the adhesive layer and the substrate layer. The surface protective layer can also protect the surface of the article. Examples of the article include, but not particularly limited to, a transportation vehicle including an automotive, a train, and an aircraft, a glass, an architecture, and a signage.

As a method for forming the surface protective layer directly on the surface of the article using the two-component curable coating agent, the same method as that for forming the surface protective layer in the multilayer film of the present invention may be performed except that the two-component curable coating agent is directly applied to the surface of the article instead of the first surface of the substrate layer.

### Effect of the Invention

The two-component curable coating agent of the present invention allows for the provision of a surface protective layer having excellent weather resistance, acid resistance, and fouling resistance. Therefore, a visually favorable appearance of the surface of an article to which such a surface protective layer is applied can be maintained over a long period of time.

Furthermore, the two-component curable coating agent of the present invention allows for the provision of a surface protective layer that is flexible and has excellent elongation properties. Therefore, when the surface protective layer is bonded to the surface of the article or when an article having the surface protective layer is molded, even if a tensile force is applied to the surface protective layer, the surface protective layer can withstand the tensile force, allowing for a reduction in the occurrence of cracking and cleavage in the surface protective layer.

### DESCRIPTION OF EMBODIMENTS

Hereinafter, the present invention will be described in more detail with reference to Examples, but the present invention is not limited thereto.

### EXAMPLES

The following raw materials were used in the production of the two-component curable coating agents of Examples and Comparative Examples.

### Synthesis of Acrylic Polyol

### Synthesis Examples 1 to 7

A reaction vessel was charged with 233 parts by mass of methyl isobutyl ketone as a solvent, and the temperature was raised to 70° C. Next, a monomer mixture liquid was prepared by stirring and mixing azobis-2-methylbutyronitrile as a polymerization initiator in a blending amount shown in Table 1 with a monomer composition containing 2-hydroxyethyl acrylate, 2-hydroxyethyl methacrylate, cyclohexyl methacrylate, n-butyl acrylate, and lauryl methacrylate in respective blending amounts shown in Table 1. The resulting monomer mixture liquid was added dropwise to the above-described solvent for 3 hours and polymerized for an additional 3 hours. As a result, an acrylic polyol solution (solid content: 30% by mass) containing an acrylic polyol was obtained.

Each of the hydroxyl value (mgKOH/g), the glass-transition temperature (° C.), and the weight-average molecular weight (Mw) of the acrylic polyols obtained in the synthesis examples is shown in Table 1.

[Polyester Polyol]
Polyester polyol (1) [a polyester polyol having an alicyclic structure (a polycondensate of adipic acid and a polyhydric alcohol having an alicyclic structure)]

[Polyisocyanate]
Polyisocyanate (1) (a bifunctional polyurethane diisocyanate obtained by performing an addition reaction of 1 mol of a diol with 2 mol of hexamethylene diisocyanate, number of isocyanate groups in one molecule: 2)
Polyisocyanate (2) (a biuret form of hexamethylene diisocyanate, number of isocyanate groups in one molecule: 3)
Polyisocyanate (3) (an isocyanurate form of hexamethylene diisocyanate, number of isocyanate groups in one molecule: 3)

### Examples 1 to 11 and Comparative Examples 1 to 7

The acrylic polyol obtained in Synthesis Examples 1 to 7, cyclohexanedimethanol, 3-methyl-1,5-pentanediol, and the polyester polyol (1) were supplied to a reaction vessel in respective blending amounts shown in Table 2, and then methyl isobutyl ketone was further supplied thereto. They were mixed to obtain a main agent (solid content: 30% by mass).

For the acrylic polyols obtained in Synthesis Examples 1 to 7, the acrylic polyol solution containing the acrylic polyol was supplied to the reaction vessel so that the amount of each acrylic polyol was the blending amount (solid content) shown in Table 2.

Next, the polyisocyanates (1) to (3) were supplied to another reaction vessel in respective blending amounts shown in Table 2, and then methyl isobutyl ketone was further supplied thereto. They were mixed to obtain a curing agent (solid content: 30% by mass). As a result, two-component curable coating agents containing the main agent and the curing agent were obtained.

In the two-component curable coating agent, an equivalent ratio (isocyanate group/hydroxyl group) of the isocyanate group of the polyisocyanate contained in the curing agent to the hydroxyl group of the polyol contained in the main agent is shown in the column of “equivalent ratio (isocyanate group/hydroxyl group)” in Table 2.

Next, the curing agent was added to the main agent and mixed. Immediately after that, the two-component curable coating agent was applied to the first surface of a substrate layer (thermoplastic polyurethane elastomer sheet with a thickness of 150 μm) using a bar coater (No. 16). The applied two-component curable coating agent was heated at 120° C. for 10 minutes, so that the solvent was removed and the agent was thermally cured, thereby forming a surface protective layer (thickness: 10 μm) laminated and integrated on the first surface of the substrate layer.

Subsequently, 100 parts by mass of an acrylic adhesive (trade name “Hariacron 560CH” manufactured by Harima Chemical Groups Inc.) and 0.5 parts by mass of an isocyanate-based cross-linking agent were mixed to obtain an adhesive composition. Immediately after that, the adhesive composition was applied to the second surface of the substrate layer using a bar coater (No. 24) to obtain a coating film. The coating film was heated at 100° C. for 3 minutes to remove the solvent. After the heating, a roller (weight: 10 kg) with a release paper wound therearound was slowly rolled on the coating film, so that the release paper was layered on the coating film. After that, the coating film was cured at 40° C. for 3 days, so that an adhesive layer (thickness: 25 μm) was formed on the second surface of the substrate layer. Thus, a multilayer film including the substrate layer, the surface protective layer that was integrally layered on the first surface of the substrate layer, and the adhesive layer that was integrally layered on the second surface of the substrate layer was obtained.

[Evaluation]

The acid resistance, weather resistance, elongation properties, and fouling resistance of the surface protective layers in the multilayer films obtained in Examples and Comparative Examples were each evaluated in accordance with the following procedures.

[Acid Resistance]

Each of the multilayer films was cut to obtain a plane rectangular specimen having a width of 20 mm and a length of 70 mm. The release paper was peeled from the specimen to expose the adhesive layer. The specimen was bonded to a center of a rectangular glass plate (25 mm in width, 75 mm in length) by intermediary of the adhesive layer to obtain a layered body. The entirety of the layered body was then immersed in an aqueous sulfuric acid solution containing 60% by mass of sulfuric acid at a temperature of 50° C. over 1 hour. From the aqueous sulfuric acid solution, the layered body was taken. The HAZE (H₁) (%) of the layered body before immersion in the aqueous sulfuric acid solution and the HAZE (H₂) (%) of the layered body after immersion in the aqueous sulfuric acid solution were each measured with a HAZE meter (trade name “HAZE METER NDH 5000” manufactured by Nippon Denshoku Industries Co., Ltd.) in accordance with JIS K 7136 (2000), and the amount of change in HAZE (%) was calculated by the following expression. The calculated amount of change in HAZE was evaluated in accordance with the following criteria. The results are shown in “acid resistant” of Table 2. Amount of change in HAZE (%)=H₂−H₁

(Criteria for Evaluating Amount of Change in HAZE)
A: The amount of change in HAZE was 0% or more and less than 2%.
B: The amount of change in HAZE was 2% or more and less than 5%.
C: The amount of change in HAZE was 5% or more and less than 10%.
D: The amount of change in HAZE was 10% or more and less than 20%.
E: The amount of change in HAZE was more than 20%.

[Weather Resistance]

The appearance of the surface protective layer in each of the multilayer films before an accelerated weathering test was visually observed in accordance with 4.4 “appearance of coating film” in JIS K 5600-1.1. All the surface protective layers in the multilayer films obtained in Examples and Comparative Examples had no uneven portion on the respective surfaces and were colorless and transparent.

Subsequently, an accelerated weathering test was performed with an accelerated weathering tester (trade name “EYE SUPER UV TESTER: SUV-W161” manufactured by IWASAKI ELECTRIC CO., LTD.) for 500 hours. In the accelerated weathering test, a step of irradiating the surface of the surface protective layer in each of the multilayer films with ultraviolet rays at an illuminance of 100 mW/cm 2 for 6 hours in an atmosphere with a temperature of 63° C. and a relative humidity of 70% and leaving the multilayer films in an atmosphere with a temperature of 50° C. and a relative humidity of 90% for 2 hours without irradiated with ultraviolet rays was repeated. The appearance of the surface protective layer in each of the multilayer films after the accelerated weathering test was visually observed in accordance with 4.4 “appearance of coating film” in JIS K5600-1.1 and evaluated in accordance with the following criteria. The results are shown in “weather resistant” of Table 2.

(Criteria for Evaluation of Appearance of Surface Protective Layer after Accelerated Weathering Test)
A: No uneven portion was formed on the surface of the surface protective layer, and the surface protective layer was not discolored into yellow or white.
B: An uneven portion was formed on a slightly small portion of the surface of the surface protective layer, but the surface protective layer was not discolored into yellow or white.
C: An uneven portion was formed on many portions of the surface of the surface protective layer, and many portions of the surface protective layer were discolored into yellow or white.
D: An uneven portion was formed on the entirety of the surface of the surface protective layer, and the surface protective layer was entirely discolored into yellow and white.

[Elongation Properties]

Each of the multilayer films was cut into a shape of “specimen type 5” specified by JIS K 7127, and the release paper was peeled and removed to obtain a specimen (25 mm in width, 115 mm in length). The elongation ratio of the specimen was measured with a tensile tester (product name “Precision universal tensile tester Autograph AGS-×” manufactured by Shimadzu Corporation) in accordance with “Plastics-Determination of tensile properties” of JIS K 7127. Specifically, the specimen was stretched under conditions including a tensile speed of 100 mm/min, a distance between chucks of 80 mm, a gauge length of 50 mm, and a temperature of 23° C. At a time point when the surface protective layer was cracked, the gauge length L (mm) of the specimen was measured, and the elongation ratio was calculated by the following expression. The calculated elongation ratio was evaluated in accordance with the following criteria. The results are shown in “elongation properties” of Table 2.

Elongation Ratio (%)=100×(L−50)/50

(Evaluation criteria for elongation ratio)
A: The elongation ratio was 85% or more.
B: The elongation ratio was 80% or more and less than 85%.
C: The elongation ratio was 75% or more and less than 80%.
D: The elongation ratio was less than 75%.

[Fouling Resistance]

On the surface of the surface protective layer in each of the multilayer films, a line was drawn with a commercially available oil-based marker (trade name “Mckee” available from ZEBRA Co., Ltd.”) and then left for 1 minute. Subsequently, 0.1 g of n-hexadecane was dropped on the line drawn on the surface of the surface protective layer. The n-hexadecane attached to the surface of the surface protective layer was wiped off ten times with a cellulose non-woven fabrics (trade name “BEMCOT M-3” available from Asahi Kasei Corporation) under application of a load of 300 g. The appearance of the surface protective layer was then visually observed in accordance with 4.4 “appearance of coating film” in JIS K 5600-1.1 and evaluated in accordance with the following criteria. The results are shown in “fouling resistance” of Table 2.

(Criteria for Evaluation of Appearance of Surface Protective Layer after Wiping)
A: The line drawn on the surface of the surface protective layer was completely wiped off. The line was no longer visible.
B: The line drawn on the surface of the surface protective layer was significantly faintly seen.
C: The line drawn on the surface of the surface protective layer was faintly seen.
D: The line drawn on the surface of the surface protective layer was clearly seen.

TABLE 1

| | | | Synthesis Example | | | | | | |
|---|---|---|---|---|---|---|---|---|---|
| | | | 1 | 2 | 3 | 4 | 5 | 6 | 7 |
| Blending | Hydroxyl group- | 2-Hydroxyethyl | 0 | 0 | 0 | 26 | 27 | 0 | 0 |
| amount | containing | acrylate | | | | | | | |
| (part by | (meth)acrylic | 2-Hydroxyethyl | 7 | 8 | 16 | 0 | 0 | 16 | 16 |
| mass) | monomer | methacrylate | | | | | | | |
| | (Meth)acrylic | Cyclohexyl | 25 | 25 | 25 | 25 | 25 | 0 | 15 |
| | monomer having | methacrylate | | | | | | | |
| | alicyclic structure | | | | | | | | |
| | Alkyl | n-Butyl | 53 | 47 | 0 | 0 | 0 | 84 | 60 |
| | (meth)acrylate | acrylate | | | | | | | |
| | | Lauryl | 15 | 20 | 59 | 49 | 48 | 0 | 9 |
| | | methacrylate | | | | | | | |
| | Polymerization | Azobis-2- | 4 | 4 | 4 | 4 | 4 | 4 | 4 |
| | initiator | methylbutyronitrile | | | | | | | |
| | Solvent | Methyl isobutyl | 233 | 233 | 233 | 233 | 233 | 233 | 233 |
| | | ketone | | | | | | | |

| | | | | | | | | |
|---|---|---|---|---|---|---|---|---|
| Acrylic | Hydroxyl value [mgKOH/g] | 30 | 36 | 70 | 125 | 130 | 70 | 70 |
| polyol | Glass transition temperature [° C.] | −30 | −30 | −28 | −30 | −30 | −42 | −30 |
| | Weight-average molecular weight (Mw) | 40,000 | 40,000 | 40,000 | 40,000 | 40,000 | 40,000 | 40,000 |

TABLE 2

| | | | Example | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Blending | Acrylic polyol | Synthesis Example 1 (alicyclic | 0 | 0 | 0 | 0 | 0 | 0 | 0 | 0 | 0 | 0 | 0 |
| amount of | | structure: presence, hydroxyl | | | | | | | | | | | |
| main agent | | value: 30 [mgKOH/g]) | | | | | | | | | | | |
| (part by | | Synthesis Example 2 (alicyclic | 0 | 75 | 0 | 0 | 0 | 0 | 0 | 0 | 0 | 0 | 0 |
| mass) | | structure: presence, hydroxyl | | | | | | | | | | | |
| | | value: 36 [mgKOH/g]) | | | | | | | | | | | |
| | | Synthesis Example 3 (alicyclic | 75 | 0 | 0 | 75 | 75 | 75 | 85 | 40 | 91 | 34 | 0 |
| | | structure: presence, hydroxyl | | | | | | | | | | | |
| | | value: 70 [mgKOH/g]) | | | | | | | | | | | |
| | | Synthesis Example 4 (alicyclic | 0 | 0 | 75 | 0 | 0 | 0 | 0 | 0 | 0 | 0 | 0 |
| | | structure: presence, hydroxyl | | | | | | | | | | | |
| | | value: 125 [mgKOH/g]) | | | | | | | | | | | |
| | | Synthesis Example 5 (alicyclic | 0 | 0 | 0 | 0 | 0 | 0 | 0 | 0 | 0 | 0 | 0 |
| | | structure: presence, hydroxyl | | | | | | | | | | | |
| | | value: 130 [mgKOH/g]) | | | | | | | | | | | |
| | | Synthesis Example 6 (alicyclic | 0 | 0 | 0 | 0 | 0 | 0 | 0 | 0 | 0 | 0 | 0 |
| | | structure: no, hydroxyl value: | | | | | | | | | | | |
| | | 70 [mgKOH/g]) | | | | | | | | | | | |
| | | Synthesis Example 7 (alicyclic | 0 | 0 | 0 | 0 | 0 | 0 | 0 | 0 | 0 | 0 | 75 |
| | | structure: presence, hydroxyl | | | | | | | | | | | |
| | | value: 70 [mgKOH/g]) | | | | | | | | | | | |
| | Alkyl polyol | Cyclohexanedimethanol | 25 | 25 | 25 | 25 | 25 | 0 | 15 | 60 | 9 | 66 | 25 |
| | | 3-Methyl-1,5-pentanediol | 0 | 0 | 0 | 0 | 0 | 25 | 0 | 0 | 0 | 0 | 0 |
| | Polyester polyol | Polyester polyol (1) (alicyclic | 0 | 0 | 0 | 0 | 0 | 0 | 0 | 0 | 0 | 0 | 0 |
| | | structure: presence) | | | | | | | | | | | |
| Blending | Polyisocyanate | Polyisocyanate (1) (number of | 0 | 0 | 0 | 117 | 0 | 0 | 0 | 0 | 0 | 0 | 0 |
| amount of | | NCO groups: 2) | | | | | | | | | | | |
| curing agent | | Polyisocyanate (2) (number of | 0 | 0 | 0 | 0 | 79 | 0 | 0 | 0 | 0 | 0 | 0 |
| (part by mass) | | NCO groups: 3, biuret form) | | | | | | | | | | | |
| | | Polyisocyanate (3) (number of | 85 | 76 | 99 | 0 | 0 | 100 | 61 | 170 | 48 | 184 | 85 |
| | | NCO groups: 3, isocyanurate form) | | | | | | | | | | | |

| Equivalent ratio (isocyanate group/hydroxyl group) | | 1 | 1 | 1 | 1 | 1 | 1 | 1 | 1 | 1 | 1 | 1 |
|---|---|---|---|---|---|---|---|---|---|---|---|---|
| Evaluation | Acid resistance | A | A | A | B | B | A | A | A | A | B | B |
| | Weather resistance | A | A | A | A | A | A | A | A | A | B | A |
| | Elongation properties | A | A | A | A | A | A | A | A | B | A | A |
| | Fouling resistance | A | A | A | B | A | B | A | A | B | A | A |

| | | | Comparative Example | | | | | | |
|---|---|---|---|---|---|---|---|---|---|
| | | | | 2 | 3 | 4 | 5 | 6 | 7 |
| Blending | Acrylic polyol | Synthesis Example 1 (alicyclic | 0 | 75 | 0 | 0 | 75 | 0 | 0 |
| amount of | | structure: presence, hydroxyl | | | | | | | |
| main agent | | value: 30 [mgKOH/g]) | | | | | | | |
| (part by | | Synthesis Example 2 (alicyclic | 0 | 0 | 0 | 0 | 0 | 0 | 0 |
| mass) | | structure: presence, hydroxyl | | | | | | | |
| | | value: 36 [mgKOH/g]) | | | | | | | |
| | | Synthesis Example 3 (alicyclic | 0 | 0 | 0 | 75 | 0 | 100 | 0 |
| | | structure: presence, hydroxyl | | | | | | | |
| | | value: 70 [mgKOH/g]) | | | | | | | |
| | | Synthesis Example 4 (alicyclic | 0 | 0 | 0 | 0 | 0 | 0 | 0 |
| | | structure: presence, hydroxyl | | | | | | | |
| | | value: 125 [mgKOH/g]) | | | | | | | |
| | | Synthesis Example 5 (alicyclic | 0 | 0 | 75 | 0 | 0 | 0 | 0 |
| | | structure: presence, hydroxyl | | | | | | | |
| | | value: 130 [mgKOH/g]) | | | | | | | |
| | | Synthesis Example 6 (alicyclic | 75 | 0 | 0 | 0 | 0 | 0 | 0 |
| | | structure: no, hydroxyl value: | | | | | | | |
| | | 70 [mgKOH/g]) | | | | | | | |
| | | Synthesis Example 7 (alicyclic | 10 | 0 | 0 | 0 | 0 | 0 | 0 |
| | | structure: presence, hydroxyl | | | | | | | |
| | | value: 70 [mgKOH/g]) | | | | | | | |
| | Alkyl polyol | Cyclohexanedimethanol | 25 | 25 | 25 | 0 | 0 | 0 | 100 |
| | | 3-Methyl-1,5-pentanediol | 0 | 0 | 0 | 0 | 0 | 0 | 0 |
| | Polyester polyol | Polyester polyol (1) (alicyclic | 0 | 0 | 0 | 25 | 25 | 0 | 0 |
| | | structure: presence) | | | | | | | |
| Blending | Polyisocyanate | Polyisocyanate (1) (number of | 0 | 0 | 0 | 0 | 0 | 0 | 0 |
| amount of | | NCO groups: 2) | | | | | | | |
| curing agent | | Polyisocyanate (2) (number of | 0 | 0 | 0 | 0 | 0 | 0 | 0 |
| (part by mass) | | NCO groups: 3, biuret form) | | | | | | | |
| | | Polyisocyanate (3) (number of | 85 | 75 | 100 | 53 | 28 | 24 | 268 |
| | | NCO groups: 3, isocyanurate form) | | | | | | | |

| Equivalent ratio (isocyanate group/hydroxyl group) | | 1 | 1 | 1 | 1 | 1 | 1 | 1 |
|---|---|---|---|---|---|---|---|---|
| Evaluation | Acid resistance | C | C | A | B | B | A | D |
| | Weather resistance | A | C | A | A | B | A | D |
| | Elongation properties | A | A | D | A | A | B | A |
| | Fouling resistance | C | C | A | C | D | D | A |

### INDUSTRIAL APPLICABILITY

According to the present invention, it is possible to provide a two-component curable coating agent capable of forming a surface protective layer having excellent weather resistance, acid resistance, fouling resistance, and elongation properties. According to the surface protective layer formed from the cured film of the two-component curable coating agent, the surface of an article can be protected from fouling and damage, and an excellent appearance can be maintained.

### CROSS-REFERENCE TO RELATED APPLICATION

This application claims priority from Japanese Patent Application No. 2021-35995, filed on Mar. 8, 2021, the disclosure of which is incorporated herein by reference in its entirety.

1. A two-component curable coating agent comprising:
a main agent that contains a polyol containing an acrylic polyol having an alicyclic structure and a hydroxyl value of 36 mgKOH/g or more and 125 mgKOH/g or less, and an alkyl polyol; and
a curing agent that contains a polyisocyanate.

2. The two-component curable coating agent according to claim 1, wherein a content of the acrylic polyol in the polyol is 35 parts by mass or more and 90 parts by mass or less, relative to 100 parts by mass of a total amount of the acrylic polyol and the alkyl polyol.

3. The two-component curable coating agent according to claim 1, wherein the alkyl polyol includes a cycloalkyl polyol.

4. The two-component curable coating agent according to claim 1, wherein the polyisocyanate has three or more isocyanate groups in one molecule.

5. The two-component curable coating agent according to claim 1, wherein the polyisocyanate includes an isocyanurate form of a polyisocyanate.

6. A multilayer film comprising:
a substrate layer; and
a surface protective layer that is integrally layered on a first surface of the substrate layer and is a cured film of the two-component curable coating agent according to claim 1.

7. The multilayer film according to claim 6, comprising an adhesive layer that is integrally layered on a second surface of the substrate layer.
